(19) United States
(12) Patent Application Publication
(10) Pub. No.: US 2015/0071764 A1
(43) Pub. Date: Mar. 12, 2015

(54) Turbocompound Bearing for Attaching a Turbocompound System to an Internal Combustion Engine

(71) Applicant: Voith Patent GmbH, Heidenheim (DE)

(72) Inventors: Eugen Morgunov, Aalen (DE); Ralf Hirzel, Welzheim (DE); Thomas Figler, Crailsheim (DE)

(21) Appl. No.: 14/391,861

(22) PCT Filed: Apr. 19, 2013
(86) PCT No.: PCT/EP2013/058221

§ 371 Date: Oct. 10, 2014

(30) Foreign Application Priority Data
Apr. 20, 2012 (DE) 10 2012 007 765.3

(51) Int. Cl. F04D 25/02; F02B 33/34; F02B 39/08

(52) U.S. Cl. CPC F04D 25/022; F02B 39/08; F02B 33/34
USPC 415/123

(57) ABSTRACT

A turbocompound bearing for attaching a turbocompound system to an internal combustion engine comprises an exhaust gas turbine having a turbine shaft mounted in a turbine bearing housing, a hydrodynamic clutch having a clutch shaft mounted in a clutch bearing housing, and having a connector for attachment of the internal combustion engine. The invention is characterized in that the connector is formed by a plate-shaped base support which has at least one first centering surface on which the clutch bearing housing is oriented, and the plate-shaped base support and/or the clutch bearing housing has at least one second centering surface on which the turbine bearing housing is oriented.

The present invention relates to a turbocompound bearing for attaching a turbocompound system to an internal combustion engine, specifically according to the preamble of Claim 1.

Turbocompound systems have an exhaust gas turbine, which is positioned in the exhaust gas stream of an internal combustion engine to convert exhaust gas energy into drive power, which is in turn returned to the driveshaft (crankshaft) of the internal combustion engine. The efficiency of the internal combustion engine can be improved and the fuel consumption can be reduced in this way.

WO 2008/135288 A1 describes a turbocompound system having an exhaust gas turbine, also called an exhaust gas power turbine, which transmits its drive power via a hydrodynamic clutch to the crankshaft of an internal combustion engine, in the exhaust gas stream of which it is positioned, wherein the exhaust gas power turbine also represents the turbine of a turbocharger having a flow compressor for turbocharging the internal combustion engine. In contrast to conventional embodiments, the turbocharger compressor is not positioned on a shared shaft with the exhaust gas turbine, but rather the turbine and the compressor each have a shaft having a pinion and both pinions mesh with a gearwheel carried by the hydrodynamic clutch on its outer circumference. Such an embodiment offers the advantage of a particularly compact arrangement of exhaust gas turbine, flow compressor, and hydrodynamic clutch and also the output, which is switched in a connection to the driveshaft of the internal combustion engine and is generally represented by a gearwheel.

One problem in practice in the above-described embodiment is that the turbocompound system has a variety of individual assemblies and interfaces, which must be centered in relation to one another to enable correct and low-wear operation, which results in a high and error-prone installation effort during the attachment of the individual assemblies to an internal combustion engine.

The present invention is based on the object of specifying a turbocompound bearing for attaching a turbocompound system to an internal combustion engine, which offers a compact arrangement of the individual assemblies and also enables a secure and rapid installation of the turbocompound system on the internal combustion engine.

The object according to the invention is achieved by a turbocompound bearing having the features of Claim 1. Advantageous and particularly expedient embodiments of the invention are specified in the dependent claims.

A turbocompound bearing according to the invention for attaching a turbocompound system to an internal combustion engine comprises an exhaust gas turbine having a turbine shaft mounted in a turbine bearing housing, furthermore a hydrodynamic clutch having a clutch shaft mounted in a clutch bearing housing, and a connector for fastening the internal combustion engine or the clutch and/or the exhaust gas turbine on the internal combustion engine.

According to the invention, the connector is formed by a plate-shaped base support. The base support therefore at least substantially has the shape of a plate, according to one embodiment a substantially flat plate, which can be attached to the internal combustion engine, for example, on an engine housing of the internal combustion engine, in particular frontally thereon. The plate-shaped base support can also be formed by a part of the engine housing itself.

The plate-shaped base support has at least one first centering surface, on which the clutch bearing housing is aligned. The clutch bearing housing aligned can therefore be exactly aligned or centered in relation to the plate-shaped base support by application to the first centering surface.

According to the invention, the plate-shaped base support and/or the clutch bearing housing has at least one second centering surface, on which the turbine bearing housing is aligned. The turbine bearing housing can thus be aligned and/or centered exactly on the base support and/or the clutch bearing housing.

A favorable embodiment according to the invention provides that the hydrodynamic clutch has a primary wheel and a secondary wheel, which with one another form a toroidal working chamber fillable with a working medium, and the primary wheel has a drive connection to the turbine shaft and also the secondary wheel has a drive connection to an output for the connection to a driveshaft of the internal combustion engine. According to this embodiment, furthermore the clutch bearing housing is plugged through or plugged into the base support and is positioned in this case in relation to the base support in such a manner that the drive connection between the primary wheel and the turbine shaft is formed at least partially on a first side of the base support, and the drive connection between the secondary wheel and the output is formed at least partially on a second side of the base support, which faces away from the first side.

For example, the drive connection between the primary wheel and the turbine shaft can be formed by an outer gearwheel, which is positioned on the primary wheel or adjacent to the primary wheel, of the hydrodynamic clutch and a turbine gearwheel provided on or at the turbine shaft.

The drive connection between the secondary wheel and the output can be formed, for example, by the clutch shaft, which carries the secondary wheel or is attached thereon, and a pinion positioned or attached thereon on the side of the output, which has a drive connection to the output. For example, the pinion meshes directly with a gearwheel which forms the output or is arranged on an output shaft forming the output, or, according to an alternative embodiment, the pinion meshes with an intermediate gearwheel, which is mounted on the base support or another component, and which in turn meshes with a gearwheel forming the output or a gearwheel on the output shaft. Other embodiments are possible.

If the clutch shaft carries the primary wheel and/or the secondary wheel on one of its two ends and a pinion, which has a drive connection to the output or the turbine shaft, on the other of its two ends, it is favorable if the clutch shaft is positioned guided through an opening in the base support to be able to establish the corresponding drive connections on both sides of the base support.

For example, the base support has a first opening, which the turbine shaft is positioned plugged through, and a second opening, which the clutch housing is positioned plugged through or into which the clutch housing is positioned plugged.

A particularly advantageous embodiment provides that furthermore a flow compressor having a compressor shaft mounted in a compressor bearing housing is provided and the base support and/or the clutch housing has/have at least one third centering surface, on which the compressor bearing housing is aligned. Therefore, the compressor bearing housing can be aligned or centered easily on the clutch housing and/or the base support while touching the third centering surface.

It is favorable if in this case the base support has a third opening, through which the compressor bearing housing and/or the compressor shaft is positioned plugged or in which the compressor bearing housing and/or the compressor bearing shaft is positioned plugged.

For example, the compressor shaft carries a compressor gearwheel, which has a drive connection to the primary wheel of the hydrodynamic clutch. In this case, it is particularly favorable if the compressor shaft carries a compressor wheel on a first side of the base support and the turbine shaft carries a turbine wheel on a second side of the base support, which faces away from the first side.

Furthermore, it can be provided that the turbine shaft carries a turbine gearwheel and the compressor shaft carries a compressor gearwheel and both gearwheels mesh with an outer gearwheel on the outside of the hydrodynamic clutch or axially adjacent to the hydrodynamic clutch.

An advantageous embodiment according to the invention provides that the second centering surface, i.e., the centering surface for aligning the turbine bearing housing in relation to the hydrodynamic clutch, is formed by a first shoulder, which is completely circumferential or is interrupted one or more times in the circumferential direction, on the clutch bearing housing having a surface oriented radially outward, which is enclosed by a shoulder having a surface oriented radially inward of the turbine housing. The turbine bearing housing can therefore be more or less plugged onto the clutch bearing housing, to align it in relation to the clutch bearing housing and therefore produce the exact engagement of the drive connection between the hydrodynamic clutch and the exhaust gas turbine.

It is particularly favorable if the third centering surface is formed by a second shoulder, which is completely circumferential or is interrupted one or more times in the circumferential direction, on the clutch bearing housing having a surface oriented radially outward, which is enclosed by a shoulder having a surface oriented radially inward of the compressor bearing housing. Therefore, the compressor bearing housing can be more or less plugged onto the clutch bearing housing, to align the two housings in relation to one another and therefore to exactly position the engagement for the drive connection between the hydrodynamic clutch and the flow compressor.

The first shoulder and/or the second shoulder on the clutch bearing housing can be formed by a plurality, in particular three or more individual arms arranged distributed over the circumference.

The turbine bearing housing can completely enclose one axial end of the clutch bearing housing and can advantageously be sealed in relation to the base support. For example, the turbine bearing housing is screwed or flanged onto the base support, advantageously over the entire circumference of the turbine bearing housing.

The compressor bearing housing can completely enclose one axial end, in particular the axial end of the clutch bearing housing opposite to the axial end enclosed by the turbine bearing housing. It is also favorable here to seal the compressor bearing housing in relation to the base support and in particular to screw or flange it thereon, advantageously over the entire circumference of the compressor bearing housing.

An oil transfer point can be provided between the compressor bearing housing and the hydrodynamic clutch. Additionally or alternatively, an oil transfer point can also be provided between the turbine bearing housing and the hydrodynamic clutch. This or these oil transfer point(s) can be used, for example, for lubricating the gear tooth engagement between the compressor gearwheel and/or turbine gearwheel and the clutch gearwheel. It is also possible to lubricate the bearing of the clutch shaft using the oil from the exhaust gas turbine and/or from the flow compressor.

Both plain bearings and also roller bearings come into consideration for all bearings. In particular, a so-called hybrid bearing also comes into consideration for the clutch shaft, the turbine shaft, and/or the compressor shaft, in which the shaft is mounted both using a plain bearing, in particular a floating bush bearing, and also using a roller bearing, for example, a roll bearing or ball bearing. For example, the plain bearing, in particular a floating bush bearing, can be provided on one axial end, and the roller bearing can be provided on the other axial end.

The structure according to the invention of the mounting enables rapid and cost-effective and also failsafe installation of the various components of the turbocompound system. Furthermore, the simple capability results of installing flow machines of various sizes, without substantial reconfiguration of the design or alignment.

One embodiment provides that the working space of the hydrodynamic clutch is supplied with working medium via one or more channels in the clutch shaft. For this purpose, for example, an opening can be provided in the compressor bearing housing and/or turbine bearing housing, which overlaps one axial end of the clutch shaft according to one embodiment, to supply or discharge the working medium. Correspondingly, a rotary feedthrough for the working medium can be provided in the compressor bearing housing and/or the turbine bearing housing. However, embodiments without working medium feedthroughs in the housing in the region of the end side of the clutch shaft also come into consideration.

One embodiment provides that the compressor wheel is attached to the compressor shaft, in particular plugged thereon or plugged therein, outside the compressor bearing housing.

One embodiment provides that the turbine wheel is attached to the turbine shaft, in particular plugged thereon or plugged therein, outside the turbine bearing housing.

In the above-mentioned embodiments, in each case a separate housing can be provided for the turbine wheel or the compressor wheel, which is installed on the turbine bearing housing or the compressor bearing housing and/or the base support. These housings can form an inflow channel or outflow channel, for example, in the form of a spiral and/or having an axial, radial, or tangential inflow or outflow.

The invention will be described in greater detail as an example hereafter on the basis of an exemplary embodiment and the figures.

In the figures:

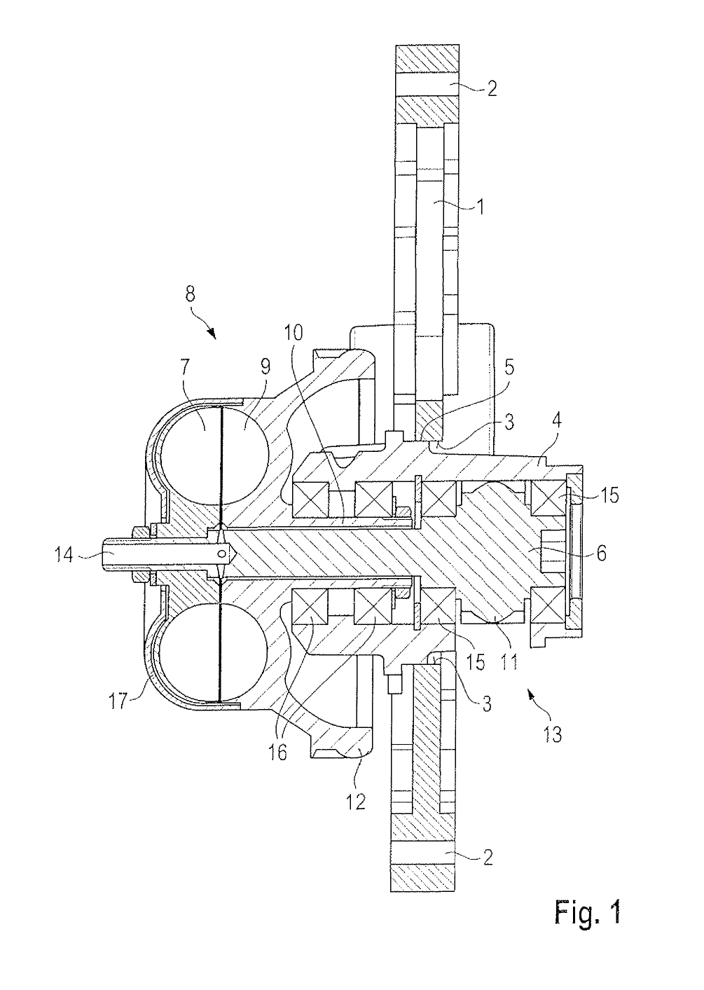

FIG. 1 shows a first view of a turbocompound bearing embodied according to the invention having a turbine bearing housing installed in the base support;

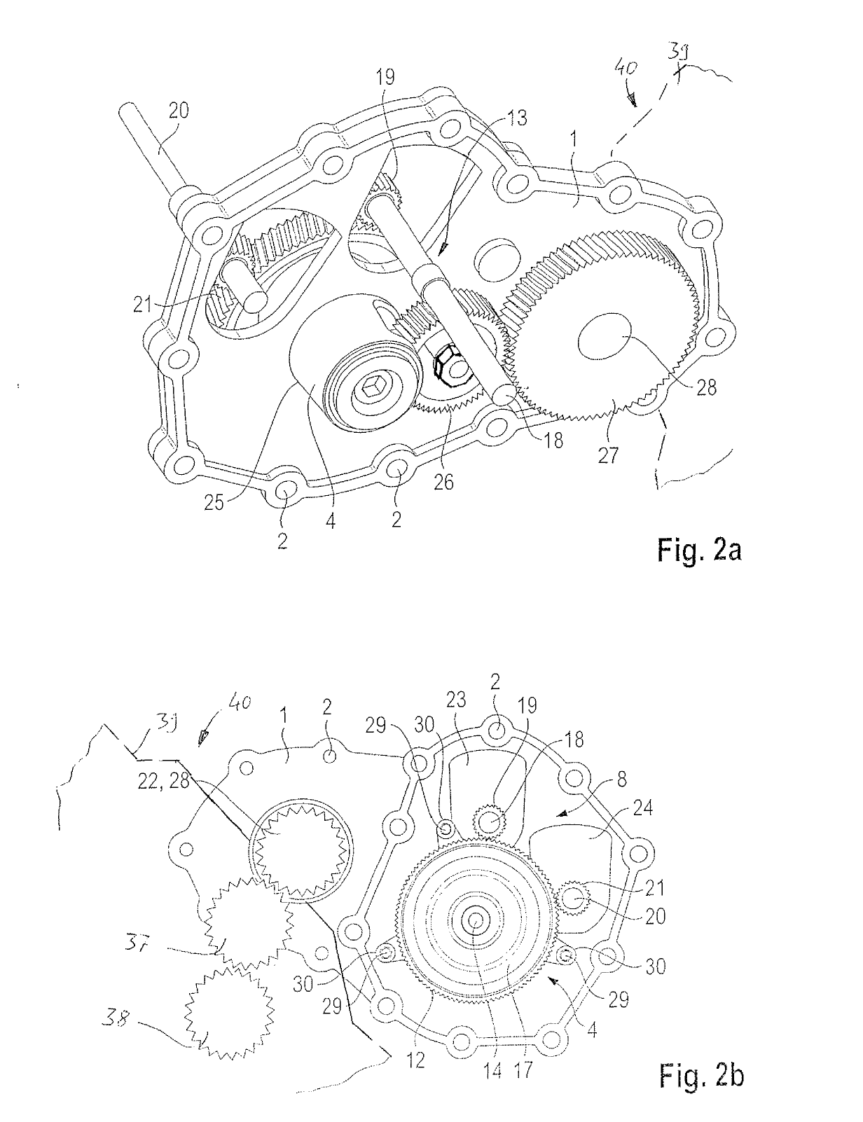

FIG. 2 shows two different views of the assembly from FIG. 1, supplemented with the turbine shaft, the compressor shaft, and the various gearwheels for establishing the drive connections;

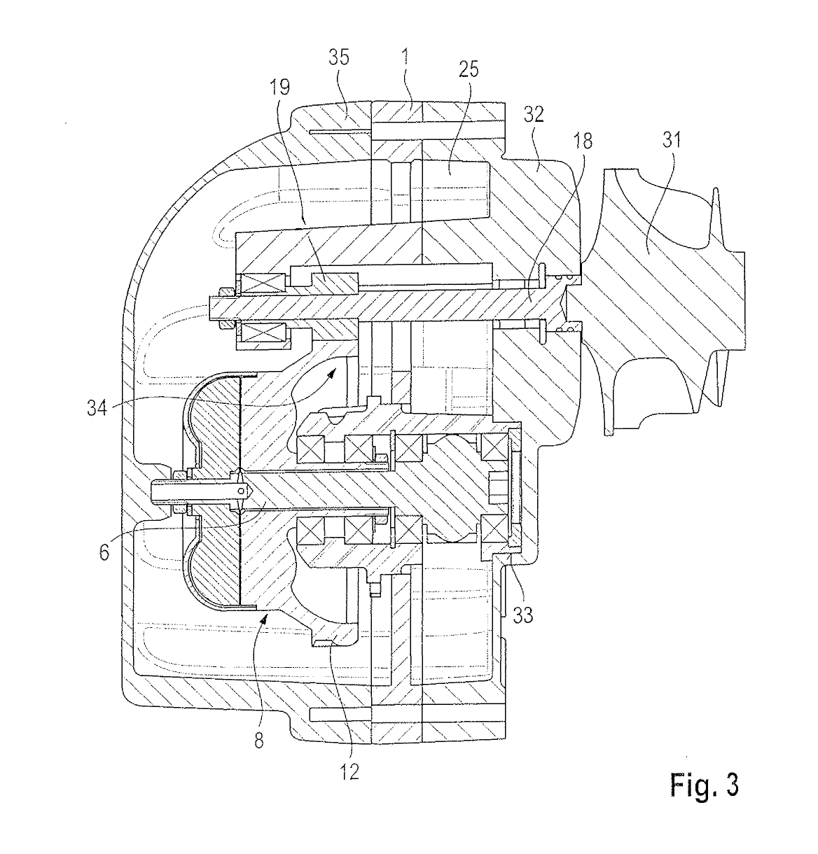

FIG. 3 shows a sectional view according to FIG. 1 having additionally installed turbine bearing housing and turbine wheel placed on the turbine shaft and also installed compressor housing in a section through the turbine shaft;

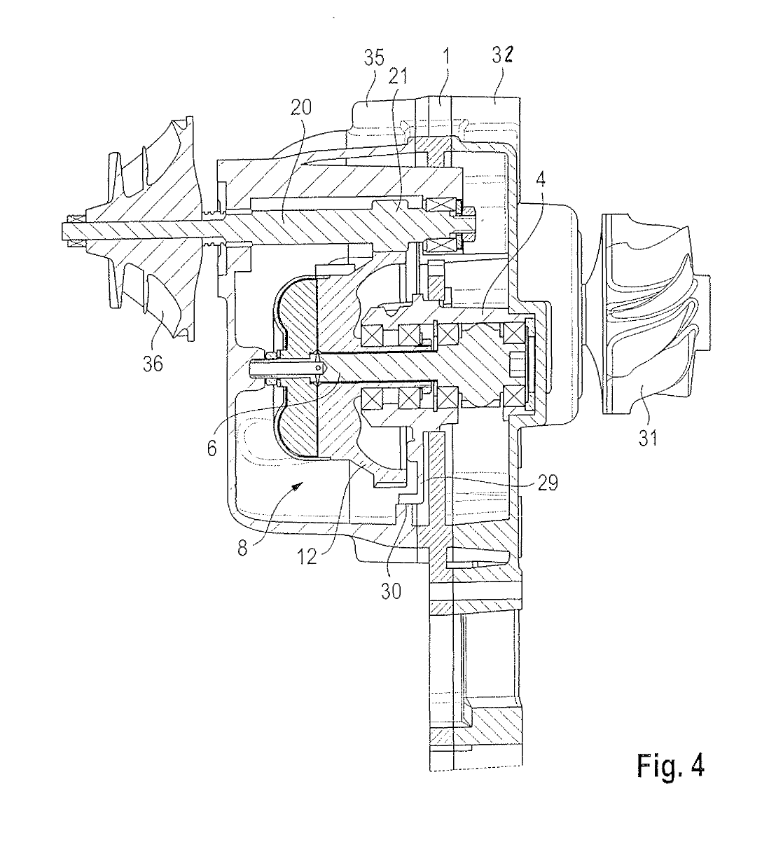

FIG. 4 shows the assembly according to FIG. 3, but in a section through the compressor shaft, therefore offset in the circumferential direction around the clutch shaft in relation to the section according to FIG. 3.

In FIG. 1, the plate-shaped base support is provided with the reference sign 1.

This has, as is also apparent from FIG. 2 in particular, openings 2 along its outer circumference for attaching or screwing on the turbine bearing housing and the compressor bearing housing (not shown in FIGS. 1 and 2).

A first centering surface 3 is formed by the inner edge of a through opening in the base support 1, through which the clutch bearing housing 4 is plugged. The clutch bearing housing 4 has an outer shoulder 5, which presses against the first centering surface 3.

The clutch shaft 6 is mounted in the clutch bearing housing 4, for example, by the four bearings shown here, in particular roller bearings. Individual bearings or all bearings can also be embodied as plain bearings, however. Another number of bearings also comes into consideration.

The clutch shaft 6 carries the secondary wheel 7 of the hydrodynamic clutch 8 in a rotationally-fixed manner. The primary wheel 9 of the hydrodynamic clutch 8, in contrast, is mounted so it is rotatable in relation to the clutch shaft 6 in the clutch bearing housing 4, in the exemplary embodiment shown in a cantilever mounting by means of a hollow shaft 10, which encloses the clutch shaft 6.

The clutch shaft 6 carries a pinion 11. To be able to produce a meshing engagement with the pinion 11, the clutch bearing housing 4 has an engagement opening 13.

The primary wheel 9 of the hydrodynamic clutch 8 carries a clutch gearwheel 12. In the exemplary embodiment shown, this gearwheel encloses the clutch bearing housing 4, but this is not required.

The clutch shaft 6 protrudes with one axial end out of the clutch bearing housing 4. On this axial end, the hydrodynamic clutch 8, and also a working medium supply in the form of a working medium channel 14 introduced frontally into the clutch shaft 6, are positioned.

In the exemplary embodiment shown, therefore both the secondary wheel 7, which is attached to the clutch shaft 6, is mounted via the clutch shaft 6 and the associated bearing 15 in the clutch bearing housing 4, and also the primary wheel 9, which is attached to the hollow shaft 10, is mounted via the bearing 16.

FIG. 2 once again shows, in a three-dimensional view and a top view on the side having the hydrodynamic clutch 8, the base support 1 having the openings 2, the clutch bearing housing 4, and also the clutch shell 17, which is attached to the primary wheel 9 using the clutch gearwheel 12, see also the sectional view in FIG. 1 in addition in this regard.

Furthermore, the turbine shaft 18 having the turbine gearwheel 19, which meshes with the clutch gearwheel 12, and the compressor shaft 20 having the compressor gearwheel 21, which also meshes with the clutch gearwheel 12, can be seen. As shown, the turbine gearwheel 19 is arranged offset in relation to the compressor gearwheel 21 over the circumference of the clutch gearwheel 12, for example, by an angle between 10° and 120°, in particular less than 90°.

Furthermore, on the side of the hydrodynamic clutch 8, the output 22 can be seen, which is used for the connection to a driveshaft of an internal combustion engine 40, to transmit drive power to the driveshaft or to transmit drive power to the output 22 from the driveshaft and in this way to drive the flow compressor for turbocharging the internal combustion engine 40. The connection of the output 22 to a crankshaft (or a driveshaft in general) of the internal combustion engine 40 can be established, for example, by a first gearwheel 37 and a second gearwheel 38 inside the internal combustion engine 40, wherein the first gearwheel 37 meshes with a pinion formed by the output 22, the second gearwheel 38 meshes with the first gearwheel 37, and the second gearwheel furthermore meshes with a gearwheel on the crankshaft, optionally via further interposed gearwheels. A part of the housing 39 of the internal combustion engine 40 is shown as an example by 39 in FIGS. 2a and 2b. For example, as shown, the plate-shaped base support 1 can be attached, in particular screwed frontally onto the housing 39 of the internal combustion engine 40, in particular by means of screws through some of the openings 2. In this case, the internal combustion engine 40 is advantageously positioned on the same side of the plate-shaped base support 1 as the clutch shell 17 of the hydrodynamic clutch 8, therefore behind the plate-shaped base support 1 in the view of FIG. 2a and in front of the plate-shaped base support 1 in the view of FIG. 2b. Other embodiments are possible, of course, also an indirect attachment of the plate-shaped base support 1 on the internal combustion engine 40, i.e., with further components provided between the plate-shaped base support 1 and the internal combustion engine 40.

The turbine shaft 18 is plugged through a first opening 23 in the base support 1. The compressor shaft 20 is plugged into a third opening 24 of the base support 1 from the other side of the base support 1. The clutch bearing housing 4 is plugged through a second opening 25 of the base support 1, wherein as explained with reference to FIG. 1, this second opening 25 forms the first centering surface 3.

The drive connection to the output 22 is established by an intermediate gearwheel 26 and an output gearwheel 27 on the output shaft 28 of the output 22. The intermediate gearwheel 26 engages in the engagement opening 13 of the clutch bearing housing 4 and meshes with the pinion 11 on the clutch shaft 6.

Three arms 29 of the clutch bearing housing 4 can also be seen well in FIG. 2, which form a third centering surface 30 for centering the compressor bearing housing in relation to the hydrodynamic clutch 8, as will be explained hereafter. In the exemplary embodiment shown, the arms 29 are furthermore used for screwing the clutch bearing housing 4 onto the base support 1.

FIG. 3 shows how the turbine wheel 31 is positioned on one axial end of the turbine shaft 18. Furthermore, it can be seen how the turbine bearing housing 32 is attached to the base support 1 and simultaneously encloses a second centering surface 33 on the outside of the clutch bearing housing 4, on the axial end thereof here, to align the turbine bearing housing 32 in relation to the hydrodynamic clutch 8 having the clutch shaft 6 and particularly the clutch gearwheel 12, with which the turbine gearwheel 19 meshes. The turbine bearing housing 32 is plugged through the second opening 25 of the base support 1, together with the turbine shaft 18, and also has an engagement opening 34, to produce the meshing engagement between the pinion 12 and the turbine gearwheel 19.

The compressor bearing housing 35 is placed on the base support 1 and screwed thereon on the other side from the turbine bearing housing 32. The centering of the compressor bearing housing 35 and therefore the compressor shaft 20 mounted therein and the compressor gearwheel 21 in relation to the hydrodynamic clutch 8, particularly the clutch gearwheel 12, is clear from FIG. 4. Thus, one of the arms 29 of the clutch bearing housing 4, which forms the third centering surface 30, can be seen here.

The compressor shaft 20 carries the compressor wheel 36 outside the compressor bearing housing 35.

As can be seen in particular from the illustrations in the figures, the plate-shaped base support 1, which is produced here as a separate component, but could also be part of the internal combustion engine or the housing thereof, forms a particularly reliable connector, which aligns the components of the turbocompound system exactly in relation to the internal combustion engine, for attaching the turbocompound system to the internal combustion engine.

### LIST OF REFERENCE NUMERALS

1 base support

2 openings

3 first centering surface

4 clutch bearing housing

5 outer shoulder

6 clutch shaft

7 secondary wheel

8 hydrodynamic clutch

9 primary wheel

10 hollow shaft

11 pinion

12 clutch gearwheel

13 engagement opening

14 working medium channel

15 bearing

16 bearing

17 clutch shell

18 turbine shaft

19 turbine gearwheel

20 compressor shaft

21 compressor gearwheel

22 output

23 first opening

24 third opening

25 second opening

26 intermediate wheel

27 output gearwheel

28 output shaft

29 arm

30 third centering surface

31 turbine wheel

32 turbine bearing housing

33 second centering surface

34 engagement opening

35 compressor bearing housing

36 compressor wheel

37 first gearwheel in the internal combustion engine

38 second gearwheel in the internal combustion engine

39 housing

40 internal combustion engine

1-16. (canceled)

17. A turbocompound bearing for attaching a turbocompound system to an internal combustion engine, the turbocompound bearing comprising:
an exhaust gas turbine having a turbine shaft mounted in a turbine bearing housing;
a hydrodynamic clutch having a clutch shaft mounted in a clutch bearing housing;
a connector for fastening the internal combustion engine;
wherein the connector is formed by a plate-shaped base support, which has at least one first centering surface, on which the clutch bearing housing is aligned, and the plate-shaped base support and/or the clutch bearing housing has/have at least one second centering surface, on which the turbine hearing housing is aligned.

18. The turbocompound bearing according to claim 17, wherein the hydrodynamic clutch has a primary wheel and a secondary wheel, which form a toroidal working chamber with one another, the primary wheel has a drive connection to the turbine shaft, the secondary wheel has a drive connection to an output for connection to a driveshaft of the internal combustion engine, and the clutch bearing housing is positioned plugged through the base support or plugged therein in such a manner that the drive connection between the primary wheel and the turbine shall is at least partially formed on a first side of the base support and the drive connection between the secondary wheel and the output is at least partially formed on a second side of the base support, which faces away from the first side.

19. The turbocompound bearing according to claim 18, wherein the output is formed by an output gearwheel mounted on the base support and/or an output shaft.

20. The turbocompound bearing according to claim 18, wherein the clutch shaft carries the primary wheel or the secondary wheel on one of its two axial ends and a pinion, which has a drive connection to the output or the turbine shaft on the other of its two ends, and is positioned guided through an opening in the base support.

21. The turbocompound bearing according to claim 19, wherein the clutch shaft carries the primary wheel or the secondary wheel on one of its two axial ends and a pinion, which has a drive connection to the output or the turbine shaft on the other of its two ends, and is positioned guided through an opening in the base support.

22. The turbocompound bearing according to claim 17, wherein the base support has a first opening, through which the turbine shaft is positioned plugged through, and a second opening, through which the clutch bearing housing is positioned plugged through or which the clutch bearing housing is positioned plugged into.

23. The turbocompound bearing according to claim 18, wherein the base support has a first opening, through which the turbine shaft is positioned plugged through, and a second opening, through which the clutch bearing housing is positioned plugged through or which the clutch bearing housing is positioned plugged into.

24. The turbocompound bearing according to claim 17, wherein a flow compressor having a compressor shaft mounted in a compressor bearing housing is provided and the base support and/or the clutch bearing housing has at least one third centering surface, on which the compressor bearing housing is aligned.

25. The turbocompound bearing according to claim 18, wherein a flow compressor having a compressor shaft mounted in a compressor bearing housing is provided and the base support and/or the clutch bearing housing has at least one third centering surface, on which the compressor bearing housing is aligned.

26. The turbocompound bearing according to claim 22, wherein the base support has a third opening, through which or into which the compressor bearing housing and/or the compressor shaft is positioned plugged through or plugged into, respectively.

27. The turbocompound bearing according to claim 24, wherein the base support has a third opening, through which or into which the compressor bearing housing and/or the compressor shaft is positioned plugged through or plugged into, respectively.

28. The turbocompound bearing according to claim 24, wherein the compressor shaft carries a compressor gearwheel, which has a drive connection to the primary wheel of the hydrodynamic clutch.

29. The turbocompound hearing according to claim 24, wherein the compressor shaft carries a compressor wheel on a first side of the base support and the turbine shaft carries a turbine wheel on a second side of the base support, facing away from the first side.

30. The turbocompound bearing according to claim 28, wherein the primary wheel of the hydrodynamic clutch has a clutch gearwheel, in particular in the form of an outer gearwheel, and the turbine shaft carries a turbine gearwheel, wherein the clutch gearwheel meshes with the compressor gearwheel and the turbine gearwheel.

31. The turbocompound bearing according to claim 17, wherein the second centering surface is formed by a first shoulder, which is completely circumferential or is interrupted one or multiple times in the circumferential direction, on the clutch bearing housing having a surface oriented radially outward, which is enclosed by a shoulder, having a surface oriented radially inward, of the turbine bearing housing.

32. The turbocompound bearing according to claim 24, wherein the third centering surface is formed by a second shoulder, which is completely circumferential or is interrupted once or multiple times in the circumferential direction, on the clutch bearing housing having a surface oriented radially outward, which is enclosed by a shoulder, having a surface oriented radially inward, of the compressor bearing housing.

33. The turbocompound bearing according to claim 31, wherein the first shoulder and/or the second shoulder on the clutch bearing housing is/are formed by a plurality, in particular three or more, arms distributed over the circumference.

34. The turbocompound bearing according to claim 17, wherein the turbine bearing housing completely encloses one axial end of the clutch bearing housing.

35. The turbocompound bearing according to claim 24, wherein the compressor bearing housing completely encloses one axial end, in particular the axial end of the clutch bearing housing opposite to the axial end enclosed by the turbine bearing housing.

36. The turbocompound bearing according to claim 34, wherein the turbine bearing housing and/or the compressor bearing housing is sealed against the base support and in particular is flanged thereon, in particular over its entire circumference.
